(19) United States
(12) Patent Application Publication
(10) Pub. No.: US 2008/0198000 A1
(43) Pub. Date: Aug. 21, 2008

(54) RFID interrogation of liquid/metal

(76) Inventor: James Neil Rodgers, Langley (CA)

Correspondence Address: James Rodgers, 8853 214th Place, Langley, BC, V1M 2H9, omitted

(21) Appl. No.: 11/676,304

(22) Filed: Feb. 18, 2007

(51) Int. Cl. G08B 1/08

(52) U.S. Cl. 340/539.1

(57) ABSTRACT

A system to reduce signal to noise interference and reflection or absorption attenuation during an RFID interrogation conducted in a warehouse or distribution center environment containing items consisting of, or packaged in, metal or liquid. The system uses a printed tag intrinsic to the items to be interrogated. The interrogation is conducted at low frequency to maximize the benefits of the physical properties of low frequency electro magnetic transmissions in relationship to metal or liquid. Furthermore, the system uses laser calibrations to calculate the angle of incidence of the printed RFID transponders. This calculation is passed to an electric motor attached to the transmitting antenna of the RFID interrogator which is designed to aim the antenna. The function of this invention is to use the physical properties of metal and liquid in relationship to low frequency transmissions plus calibrated angle of incidence coefficients of transmitted electro magnetic signals and to co-ordinate same in order to maximum RFID interrogation power through a reduction of the signal to noise ratio.

### BACKGROUND OF THE INVENTION

This invention is in the field of Radio Frequency Identification, known in the industry as RFID, and herein referred to as “RFID”. RFID is a system in which radio frequency communication is used to exchange data. Usually this is done between some sort of mobile device equipped with a memory component hooked to a host computing system. An example in current usage is the ubiquitous bar code system. This is a laser scanning technology whereby information is stored within the bar code label and retrieved from a reader through a scanning process. At the end of the day the bar code data is fed into a computing system which then makes sense of the data, such as linking a product to price.

RFID systems are classified in accordance with the frequency used to excite the memory unit. They can also be classified by the type of carrier wave modulation used to interrogate the RFID tag and the method of data encoding. Many characteristics of an RFID system are determined by the excitation frequency. This includes the read/write range between the reader and tag, noise immunity, and penetration through various non-metallic objects. The excitation frequency has a bearing on antenna type, size and shape. The frequencies which are commercially available can be broken into three bands. First there is the low frequency band which operates between 100 and 500 kHz. Second the medium frequency which operates between 10 and 15 MHz. Third there is the high frequency systems which can be found at 850 to 950 MHz and at 2.4 to 5.8 GHz. There are a number of key components of an RFID system. The remote portion of the system is referred to as a tag or transponder. It contains an antenna, an integrated circuit, data storage space and can have the ability to be rewritable. In a passive set up the reader or interrogator provides power to the tag. A host computer interfaces with the reader and directs the interrogation via parallel, serial or bus communications.

The first function of the system is the initiating reader circuit which is based on a transfer of energy between two resonant circuits. The tag responds and is comprised of a coil or etched antenna and an application specific integrated circuit. The tags can be manufactured with or without internal power. Those tags without power are called passive. They are powered by charging an internal capacitor using the onboard antenna in conjunction with an externally provided electromagnetic field. Passive tags last for a long period of time and require no additional maintenance cost. In contrast, active tags are manufactured with onboard batteries to power the electronics and typically allow longer ranges between the host computer and tag via signal amplification but require battery replacement or recharging.

The operational frequency of the RFID system will determine the shape, size, and geometry for the system tag and its antenna. The tags are usually encapsulated to resist environmental affects. The encapsulation materials are usually glass or plastic. This protects the electronics from moisture, shock, corrosion, wear and electrical shorts. The antenna of an RFID system enables a device to convert current and voltage into an electro magnetic signal. Both sides of the equation, interrogator and tag, are required to have an antenna. The transmission frequency will determine whether a magnetic coil antenna, loop, patch, micro strip or an electric dipole design is required.

There is a final step in the RFID system. That is the connection to a host computing system. This system can determine in which mode the interrogator operates. In an environment were tags are passing near the antenna the interrogator can be instructed by the host computing system to always be alert to tags. However, if the antenna of the interrogator were to become portable, the host computer may instruct the reader to energize only at the users command.

The primary market for RFID systems is in any area where optical scanning is used. However, it can also be used where optics would not operate. This includes harsh environments, high speed tracking, identifying hidden items or for long range package scanning.

From a technical point of view, an electromagnetic signal can be effectively generated if the linear dimension of the antenna is comparable with the wavelength of the excitation frequency. In the low to medium frequency bands, the wavelength of the excitation frequency is close to two kilometers. This large length prohibits construction of a true dipole antenna, but a small resonating loop antenna solenoid is effective.

At low to medium RFID frequencies the interrogator and tag are linked through coil antennas. The reader and tag antenna coils are linked using near field magnetic induction coupling between the reader and tag coil antennas. A time varying current passing through the interrogator antenna coil creates a time varying magnetic field in the direction perpendicular to the coil plane. The electro magnetic field is not a propagating wave but rather an attenuating carrier wave.

Passive tags utilize the energy provided by the carrier wave through an induced antenna coil voltage. The voltage is proportional to the product of the number of turns in the tag antenna and the total magnetic flux through the antenna. The integrated circuit within the tag must receive a minimum voltage to become excited and operate. Voltage is built up though an onboard storage capacitor. When sufficient charge has accumulated to reach or surpass the circuit operating voltage, the electronics power up. This produces an electro magnetic signal sent back to the interrogator.

There are two main methods of transmitting data. First there is the full duplex model whereby the tag communicates its data by modulating the carrier wave of the interrogator. This is accomplished by applying a resistive load. A transistor which acts as a load modulator shorts the antenna circuit in sequence to the data. This removes the antenna from resonance at the excitation frequency thereby removing power draw from the interrogator's carrier wave. At the interrogator side of the equation this loading and unloading is read and the data can be reconstructed. Second, in a half duplex RFID system the carrier wave transmits power and then pauses. During the pause period the tag transmits data to the interrogator. It is imperative that both the interrogator and tag use the same transmission method in order to synchronize and successfully exchange data. The specific problem addressed by this invention is the limiting environmental factors which can influence read range. One of these factors is water. It has the effect of absorbing or reflecting the carrier wave. The degree of this influence is determined by the operating frequency band used. Furthermore, ferrous material will detune a tag by shifting its excitation frequency. Interference, absorption and reflection will have the result of decreasing the overall efficacy of the RFID system in question.

The time varying electro magnetic field will cause water molecules to oscillate from one orientation to another at the frequency of the carrier. This oscillation causes friction. This friction between the molecules converts energy to heat. This peak carrier wave absorption in water and resulting heat generation occurs at microwave frequencies around 2 GHz. The effect of energy absorbed by water denies an RFID tag within the water from its source of power and denies it an information transmission path.

The critical aspect of this absorption as it applies to the herein invention is that lower carrier wave frequencies produce less water absorption. The result is that medium to low frequency RFID systems will outperform a high frequency system in an environment where water is prevalent.

In the ferrous material environment the metal reflects or refracts radio frequency when using the ultra high frequency far field spectrum. In the ferrous material environment a low frequency system produces less reflection and refraction.

The properties of low frequency radio waves indicate that they penetrate sea water, brick and stone very easily. Low frequencies are in the 30-300 kHz range. As the frequency rises, absorption effects become more important. Absorption by molecular resonance with water or oxygen has a major effect on electro magnetic transmission.

Low frequency tags in the 125-134.2 kHz range and 140-148.5 kHz range can be used globally without a license. This is in contrast to ultra high frequency which can be used unlicensed for 902-928 MHz in the United States; however, restrictions exist for transmission power.

The useful, non-obvious and novel steps of the herein invention involve the use of a proprietary low frequency RFID system to interrogate tags in an environment containing water and metal. This low frequency could be used within the confines of a warehouse or distribution center electro magnetically isolated by aluminum oxide particulate. The initial interrogation would be by way of a microwave electro magnetic signal from a remote cellular telephone transmission tower. One of the key steps for the herein invention is through the means of printed transistors which operate within the low frequency band. Companies which are developing printed transistors are focusing on lower frequency RFID systems. One of the technologies which provide a good match between the printed chip and printed antenna contemplated herein is capacitive coupling which operates at 125 kHz, or low frequency. This technology, developed by Motorola is currently licensed to an Israeli firm, Power Paper, which intends to commercially produce the printed tag operating at 125 kHz. These tags will not be available until 2008.

Problematic to the herein invention is that the low frequency operation is incompatible with existing readers. This means that this invention is not suitable for open loop supply chains until standards emerge for item level low frequency tagging. However, it is anticipated that low frequency printed transistors should carve a market for tagging at a very low cost. It is proposed in this invention that printed transistors be used in a closed loop environment to provide asset management solutions involving products containing water or metal, or both, using a proprietary low frequency interrogation system. The trade off for a low frequency system is that although it is cheap and works in a metal/water environment, it has a short reading range.

### DESCRIPTION OF PRIOR ART

The prior art presents a patent application by Rodgers, Application Number 11627383, Title—“RFID system of modulation and re-radiation; remote interrogation” which sets out the system and method of remote interrogation using microwave cellular transmission towers as a base source. These interrogation signals are received by a super antenna at an environment, sent to a transformer at or near the warehouse shelving, then modulated and re-radiated to RFID tags embedded or attached to warehouse articles at the resonant frequency of the tags. The downlink and uplink are as stated herein and to that extent this patent writes on and relies upon the Rodgers application.

The prior art presents another patent application by Rodgers, Application Number 1167252, Title “RFID environmental manipulation” which sets out the system and method of signal to noise interference reduction by taking the initial interrogation by an electromagnetic inquiry signal of a defined area, such as a warehouse or distribution center, and enhancing the quality of said signal through environmental manipulation. This inventive step allows the signal to noise ratio in the environment to be greatly reduced. This reduction means a greater transmission success ratio, in other words an increased read rate by RFID tags, while, concurrently, a decreased power level is required from the transmitting transformer. The observed result of signal to noise reduction is due to the physical properties of aluminum oxide particulate and nighttime simulation and horizontal polarization upon radio wave propagation. A useful, non-obvious and novel step includes the system of safely introducing aluminum oxide into the environment and manipulating the environment producing the function of increased tag read rates.

In a study titled “Underwater Electromagnetic Propagation; Re-evaluating Wireless Capabilities”, by Mark Rhodes, found in The Global Magazine for Geomatics, December 2006, volume 10, number 10, there is a discussion of an important consideration contemplated herein; that being the effect of the air to water interface. Rhodes indicates that propagation losses and the refraction angle are such that an electromagnetic signal crosses the air to water boundary and appears to radiate from a patch of water directly above the transmitter. The large refraction angle produced by the high permittivity launches a signal almost parallel with the water surface. This effect aids communication from a submerged station to land and between shallow submerged stations without the need for surface repeater buoys.

This research dovetails with the inventive concept herein. Specifically this invention contemplates that the transformer located within the environment will radiate at angles of attack at measured parameters. In other words, the electro magnetic transmission will be aimed at an angle in relationship to the liquids or metals in the environment with the intent of keeping the electro magnetic transmission signal parallel to the surface of the liquid or metal. The angle of attack will be calculated using laser measuring devices located within the transformer. The function will be to determine the angle of incidence of the liquid or metal surfaces and to aim the transmitting antenna so that the electro magnetic signal interfaces with the surface of the water or metal at an angle which is the most efficient for transmission. The function of this measuring and aiming is to aid in signal strength by propagating energy parallel to the liquid surface as contemplated by the Rhodes report.

In a study titled “Study of Pipeline Robot's Localization Technology Based on Ultra-Low Frequency Electromagnetic Wave”, QUI, CHEN, ZHANG, ZHAO, GUO, Journal of Physics: Conference Series 48 (2006) 75-79, a remote localization strategy by means of ULF electromagnetic wave (23 HZ) is discussed. It is proposed as a communication medium in a metal and water environment. The 23 HZ frequency is powerful in penetration capacity through metal, soil and seawater. This transmission strategy is based on the transmission characteristics of ULF electromagnetic waves. A magnetic-dipole model is developed.

### BRIEF SUMMARY OF THE INVENTION

The useful, non-obvious and novel steps in this invention which moves it beyond the prior art can be summarized as:
1.) The system of transmitting a low frequency electro magnetic signal in a warehouse or distribution center environment in order to interrogate materials consisting of, or packaged with, liquid or metal.
2.) The system of aiming the transmission antenna in order to broadcast electro magnetic signals at low frequency to take advantage of angle of attack and angle of incidence physical properties associated with interrogating materials consisting of, or packaged with, liquid or metal.

The purpose and utility of the above is to reduce the signal to noise ratio in the environment caused by absorption of water or reflection/refraction caused by metal. The effect is to enhance the desired electromagnetic signals within the environment.

This invention is in response to a couple of RFID industry challenges.

First, there is the challenge of waking up the passive RFID tag. In order for a passive tag to reflect or backscatter a radio signal to the reader it must first gather enough energy from the signal of the reader in order to reach an excitation level of roughly 1.2 volts. This is the threshold energy required to arouse the integrated circuit contained within the RFID tag. As this invention contemplates a follow on from a microwave remote interrogation it is clear to the inventor that operation in either the 2.45 MHz or 5.8 MHz bands will have problems in terms of reflections or refractions from metal surfaces or absorption from water located in the environment. Normally, passive tags struggle to operate around metal and water. They are sensitive to the dielectric constant of metal. Accordingly, shelving and environmental materials, such as metals or liquids, can reduce the amount of electromagnetic energy which is effectively transmitted to the tag from the reader. The result may be that the tag harvests insufficient energy from the reader to sufficiently awaken itself. This invention addresses this RFID industry problem by using a transformer to re-radiate a consistent strength interrogation signal at a much lower frequency than the initial microwave inquiry. Specifically, the inventive step contemplated in this invention is a proprietary system of low frequency interrogation. This allows the signals to penetrate the articles, whether contained by or comprised of metals or liquids. This further allows the signals not to be adversely affected by reflection or refraction on metal or absorption by liquid which is the norm for the much higher frequency microwave electromagnetic energy. This invention proposes the useful, non-obvious and novel steps of low frequency interrogation at specific angles of incidence and angles of attack to reduce signal to noise ratio caused by metal or liquid in the environment.

Second, there is the challenge of insufficient energy to backscatter or reflect the energy of the initial read. As in the paragraph above, the identical energy problems are evident to the inventor. Specifically, the electromagnetic signal quality must be of high enough power to overcome the obstacles posed by environmental problems, such as reflection or refraction by metals and liquids. This is known as the signal to noise ratio. Furthermore, there is an inherent compromise in the design of passive tags. They must have the ability to both collect and backscatter an electromagnetic signal. This is a tradeoff which can result in a low power transmission meaning far less than 100% read rates. In other words, the result is often a low signal to noise ratio. The solution, as presented by the inventor, is to provide a more consistent power level through the use of low frequency interrogation at specific angles of attack to reduce signal to noise ratio.

### DETAILED DESCRIPTION OF THE INVENTION

The system of this invention relies upon, but is not dependent upon, the Rodgers Application Number 11627383, Title—“RFID system of modulation and re-radiation; remote interrogation” and involves a retransmission of a remote interrogation signal from a source, such as a cellular telephone transmission tower, (hereinafter the “remote interrogation signal”). This involves an antenna, external to the environment, which gathers, captures and collects the initial microwave electromagnetic signal which comprises the remote interrogation signal. This antenna then retransmits the remote interrogation signal through a process of modulation and re-radiation in an attachment to the antenna known as a transformer. The retransmitted electromagnetic signal is greatly enhanced in an atmosphere charged with aluminum oxide nano particulate as contemplated in the second Rodgers Application mentioned herein, specifically Application Number 11672525, titled “RFID environmental manipulation”. The aluminum oxide nano particulate (hereinafter the “particulate”) is safely, pursuant to governmental safety regulations, introduced into the environment through the heating, ventilation and air conditioning apparatus (hereinafter “HVAC”). The external antenna is required as the particulate introduced into the environment would reflect the microwave remote interrogation signal before it entered the environment. Therefore, there is a need to capture the initial microwave interrogation from the remote interrogation signal and re-radiate this signal through a transformer. The transformer is connected by wire to the external antenna and the transformer is located within the environment under the cover of the particulate. In this manner, the re-radiated electromagnetic signal is reflected and intensified within the environment. There will be a number of transformers within the environment. The concept is to properly blanket the environment with a consistent electromagnetic signal. All transformers will be connected by wire to the external antenna.

The remote microwave interrogation signal can be initiated by management of the environment. In this manner, inventory can be calculated at any time, without the need for employee input and on a time table determined by management. It is contemplated that the external antenna can uplink the data retrieved from the RFID tags back to the remote interrogation signal site or directly to the computer database controlled by the environment management team.

The system involves a process whereby the transformer transmits a continuous wave radio signal to a passive integrated circuit transponder (hereinafter the “RFID tag”). The RFID tag is embedded or attached to articles on the shelves in the environment. The RFID tags modulate the continuous wave signal using a modulated backscattering reflection of the electromagnetic radiation as transmitted by the transformer. The transformer system involves the external antenna gathering an RFID electro-magnetic signal interrogation message from a remote source, such as a cellular telephone transmission tower. This interrogation will be in the microwave frequency range to obviate any regulatory or governmental issues with bandwidth or frequency. The microwave frequency also aids to produce high speed electromagnetic signal transfer.

Furthermore, the microwave frequency is capable of handling a much heavier information load than lower frequencies. The external antenna receives this electro-magnetic interrogation signal from the cellular telephone transmission tower and passes this signal via a wired or wireless connection to an electrical transformer located within the environment. The transformer then interrogates the RFID tags embedded or attached to the articles on the shelving units in the environment through a transmission and receiving antenna contained within the transformer. During this process the transformer transmits a continuous wave radio signal to the RFID tag. The RFID tag modulates the continuous wave signal using a modulated backscattering reflection of the electro-magnetic radiation transmitted by the antenna connected to the transformer. This modulated backscatter allows signals to be passed between the RFID tags back to the transformer through the antenna connected to the transformer. The initial inquiry is known as the downlink and the backscatter response is known as the uplink. The RFID tag is designed to identify itself when it passes within the signaling range of the transformer and to store data on its integrated circuit for retrieval at a later time. This procedure can be used for the purposes of inventory management or some other useful application. The RFID tags are embedded or attached to the articles by the original article manufacturers. The RFID tag interrogation is conducted at maximum allowable power; fewer than two watts. The system contemplates a wall socket power source for the transformer. The transformer receives the microwave interrogation signal and returns electromagnetic information via a wired or wireless connection between the transformer and the external antenna. The external antenna receives the interrogation from the remote interrogation source, for example a cellular telephone transmission tower. The transformer then modulates and re-radiates the electromagnetic interrogation signal of the remote interrogation source to the embedded or attached RFID tags. This modulated and re-radiated interrogation is conducted at the resonant frequency programmed into the integrated circuit of the RFID tag, preferably low frequency 125 kHz printed tags. The RFID tag responds to the transformer interrogation through the industry standard backscatter methodology. This backscattered electromagnetic signal is modulated and re-radiated back to the external antenna in the identical microwave frequency of the initial electromagnetic signal interrogation. Instantaneously, this modulated and re-radiated backscattered electromagnetic signal is transmitted via the external antenna, on a designated microwave frequency, back to the original inquiry source or directly to management computers. Radio transmission apparatus in the transformer is the source of the radiated electromagnetic signal which is used to activate and then interrogate the RFID tags. This apparatus is also used to modulate the backscatter answer into microwave and to transmit this electromagnetic information back to the remote interrogating signal or to management computers through the external antenna.

The current invention contemplates the use of low frequency interrogation in the 125 kHz range. The interrogation will begin from transformer/antenna systems within the environment which have been excited by a high frequency microwave prompt. This excitation signal is then modulated to 125 kHz and re-radiated into the environment. However, prior to re-radiation, the transformer/antenna system will measure the angle of incidence of the electro magnetic signal in relationship to the metal or liquid surfaces of articles on the shelves of the environment. The angle of attack of the electro magnetic signals will be beamed to maximize the Rhodes effect. The combination of the low frequency and angle of attack methods will have the function of reducing signal to noise ratio within the environment. This reduction will increase the read rate of tags while concurrently reducing power requirements for the transformer/antenna.

This invention is novel in that printed circuits for low frequency tags have yet to be produced. Furthermore, there are no readers on the market available to read low frequency tags. However, it is assumed by this invention and based on the evidence of journal articles that such systems will be available during 2008.

It is contemplated that the low frequency printed tags be embedded or attached to articles within the environment which are constituted or packaged in metal or liquid. These materials have a significant effect in increasing signal to noise ratio. The current invention proposes the use of low frequency interrogation to lower the level of signal to noise ratio. This will not be feasible until 2008 and has not been contemplated in the prior art.

The concept of measuring angle of incidence involves the use of a laser measuring device which will be calibrated to calculate the orientation of tags attached to or embedded in metal or liquid articles or packaging. This laser measurement and calculation occurs at the speed of light. The calibration is done by an application specific integrated circuit located within the transformer/antenna unit located within the environment. The information is passed to an application specific integrated circuit attached to an electric motor which alters the aim, or angle of attack, of the interrogating low frequency electro magnetic signal. The angle of attack is calculated using the angle of incidence (orientation) of the tags in relationship to the transformer/antenna. There is nothing like this in the prior art. This concept is equally as applicable to metal where the angle of incidence is measured with the laser device and calibrated so that the angle of attack of the interrogation signal takes into account the reflection/refraction co-efficient of the metal surface to be penetrated. Generally, the angle of incidence equals the angle of reflection for smooth metal surfaces. There is nothing like this in the prior art.

This inventive step dovetails with the second Rodgers Application mentioned herein, specifically Application Number 11672525, titled “RFID environmental manipulation” in that it contemplates the manipulation of polarization of interrogating electro magnetic signals from vertical to horizontal. The current invention is not dependent on either Rodgers' Application but reads, in part, on both.

The embodiments of the invention in which an exclusive property or privilege is claimed are defined as follows; and what is claimed is:

1. A system for transmitting a low frequency radio frequency identification electro magnetic signal in a warehouse or distribution center environment; a system of aiming a radio frequency identification transmission antenna which is attached to an interrogator; the function of which is to reduce signal to noise ratio within the warehouse or distribution center environment; the further function of which is to take advantage of angle of attack and angle of incidence of physical properties associated with radio frequency identification interrogation of materials consisting of, or packaged with, liquid or metal.

2. The system of claim 1 whereby the low frequency range is 120 kHz to 130 kHz.

3. The system of claim 1 whereby the prompt for the low frequency radio frequency identification emanates from a remote microwave source.

4. The system of claim 1 whereby the remote microwave source of claim 3 is limited to cellular telephone transmission towers.

5. The system of claim 1 whereby the initial microwave source interrogation of claim 4 is received and modulated to the low frequency range of 120 kHz to 130 kHz and then re-radiated into the warehouse or distribution center environment.

6. The system of claim 1 whereby the re-radiation of claim 5 is triggered only after a laser calculation of the angle of incidence of the articles to be interrogated which are located within the warehouse or distribution center environment.

7. The system of claim 1 whereby the articles of claim 6 are limited to those comprised of liquid or metal, or both, or articles which are packaged in liquid or metal, or both.

8. The system of claim 1 whereby printed radio frequency identification transponders are an intrinsic part of the articles to be interrogated which are located within the warehouse or distribution center environment.

9. The system of claim 1 whereby the laser calculation of claim 6 is conducted through a laser eye connected to the radio frequency identification interrogator which calculates the orientation of the transponders of claim 8.

10. The system of claim 1 whereby the calculations of claim 9 are communicated from an application specific integrated circuit located in the radio frequency identification interrogator to an application specific integrated circuit contained within an electric motor attached to the interrogator.

11. The system of claim 1 whereby the transmitter antenna of the interrogator of claim 9 is oriented to transmit so that the angle of attack of the electro magnetic radio frequency identification signals intersect the liquid or metal surfaces at an angle calculated to reduce signal to noise ratio and to enhance the strength of the signal.

12. The system of claim 1 whereby the angle of attack uses the reflection/refraction co-efficient of the metal surface to be penetrated or the absorption co-efficient and reflection/refraction co-efficient of the liquid to be penetrated in order to perform the calculation of claim 11.
